(19) United States
(12) Patent Application Publication
(10) Pub. No.: US 2025/0326078 A1
(43) Pub. Date: Oct. 23, 2025

(54) STAGE ALIGNMENT APPARATUS AND DRIVING METHOD THEREOF

(71) Applicant: Samsung Display Co., LTD., Yongin-si (KR)

(72) Inventors: Yong Hyun KIM, Yongin-si (KR); Seung Ho MYOUNG, Yongin-si (KR); Kyu Bum KIM, Yongin-si (KR); Jae Yun CHOI, Yongin-si (KR); Gyeong Hee HAN, Yongin-si (KR)

(73) Assignee: Samsung Display Co., LTD., Yongin-si (KR)

(21) Appl. No.: 19/087,918

(22) Filed: Mar. 24, 2025

(30) Foreign Application Priority Data
Apr. 18, 2024 (KR) 10-2024-0052298
May 30, 2024 (KR) 10-2024-0070830

(51) Int. Cl. B23Q 3/18

(52) U.S. Cl. CPC B23Q 3/186

(57) ABSTRACT

A stage alignment apparatus includes a lower stage, alignment drivers disposed on the lower stage, and an upper stage aligned by the alignment drivers. Each of the alignment drivers includes a first sliding block and a second sliding block slidable in directions perpendicular to each other, and a shape of a first sliding block of at least one alignment driver among the alignment drivers is substantially different from a shape of first sliding blocks of other alignment drivers among the alignment drivers.

### CROSS-REFERENCE TO RELATED APPLICATION(S)

This application claims priority to and benefits of Korean patent application No. 10-2024-0052298 under 35 U.S.C. § 119 filed on Apr. 18, 2024 and 10-2024-0070830 filed on May 30, 2024 in the Korean Intellectual Property Office, the entire contents of which are incorporated herein by reference.

### BACKGROUND

### 1. Technical Field

The disclosure generally relates to a stage alignment apparatus and a driving method of a stage alignment apparatus.

### 2. Description of the Related Art

The alignment precision of a stage is very important in a panel process. Accordingly, it is required to develop a stage alignment apparatus for reducing tolerance occurring in movement of a stage and precisely aligning the stage.

The above information disclosed in this Related Art section is only for enhancement of understanding of the background of the disclosure and therefore it may contain information that does not form the prior art that may already be known to a person of ordinary skill in the art.

### SUMMARY

Embodiments provide a stage alignment apparatus having high durability by efficiently removing deformation caused by a vertical load, and a driving method of the stage alignment apparatus.

In accordance with an aspect of the disclosure, there is provided a stage alignment apparatus including; a lower stage; alignment drivers disposed on the lower stage; and an upper stage aligned by the alignment drivers, wherein each of the alignment drivers may include a first sliding block and a second sliding block slidable in directions perpendicular to each other, and wherein a shape of a first sliding block of at least one alignment driver among the alignment drivers is substantially different from a shape of first sliding blocks of other alignment drivers among the alignment drivers.

The first sliding block of the at least one alignment drivers may include bending blocks.

The bending blocks may be divided into a first bending block group and a second bending block group, each of the first bending block group and the second bending block group may include at least one bending block. The bending blocks included in the first bending block group may be adjacent to each other in a second direction. The first bending block group and the second bending block group may be spaced apart from each other in a first direction intersecting the second direction.

The bending blocks of the first sliding block of the at least one alignment driver may include an elastic material.

Each of the bending blocks may include a first area, a second area and a first bending area and a second bending area. The second area may face each of the first area and the third area at a surface. The first bending area may connect between the first area and the second area, and extend in a substantially bent shape. The second bending area may connect between the second area and the third area, and extend in a substantially bent shape.

Each of the bending blocks may include a first area, a second area, and a third area and a first bending area and a second bending area. The second area may face each of the first area and the third area at two surfaces. The first bending area may connect between the first area and the second area, and extend in a substantially bent shape. The second bending area may connect between the second area and the third area, and extend in a substantially bent shape.

Each of the bending blocks may include a first area, a second area, and a third area and a first bending area, a second bending area, a third bending area and a fourth bending area. The second area may face each of the first area and the third area at a surface. The first bending area and the second bending area may overlap each other in a second direction. The third bending area and the fourth bending area may overlap each other in the second direction. The first bending area and the second bending area may connect between the first area and the second area, and extend in a substantially bent shape. The third bending area and the fourth bending area may connect between the second area and the third area, and extend in a substantially bent shape.

The alignment drivers may include a first alignment driver, a second alignment driver, a third alignment driver and a fourth alignment driver.

Each of the alignment drivers may further include a first guide block disposed between the lower stage and the first sliding block; a second guide block disposed between the first sliding block and the second sliding block; a supporter disposed on the second sliding block, to connect between each of the alignment drivers and the upper stage; a transfer motor transferring the first sliding block in a direction; and a ball screw connecting between the first sliding block and the transfer motor.

The ball screw may have a substantially cylindrical shape and extend in a direction.

The supporter may include a protrusion portion disposed at an upper surface of the supporter. The upper stage may include holes in a number of areas. The protrusion portion of each of the alignment drivers may be connected to each of the holes of the upper stage, to support the upper stage on the alignment drivers.

The first guide block may be connected to the lower stage, and limit a sliding direction of the first sliding block. The second guide block may be connected to the first sliding block, and limit a sliding direction of the second sliding block.

The first sliding block of each of the at least one alignment drivers among the alignment drivers may include an upper surface on which the second guide block is disposed; and a lower surface connected to the ball screw, to transfer power to the transfer motor.

The first sliding block of the at least one alignment driver may include a body connected to the ball screw, to transfer power to the transfer motor, the body including a portion having substantially arch shape; and bending blocks connected on the body.

In accordance with another aspect of the disclosure, there is provided a method of driving a stage alignment apparatus including alignment drivers including a first sliding block and a second siding block slidable in directions perpendicular to each other and an upper stage aligned by the alignment drivers, the method including moving the upper stage by moving the first sliding block of each of the alignment drivers; and moving the second sliding block of each of the alignment drivers according to a movement of the upper stage, wherein a shape of a first sliding block of at least one alignment driver among the alignment drivers is substantially different from a shape of first sliding blocks of other alignment drivers among the at least one alignment drivers.

The first sliding block of the at least one alignment driver may include bending blocks.

The bending blocks may be divided into a first bending block group and a second bending block group, each of which may include at least one bending block. The bending blocks included in the first bending block group may be adjacent to each other in a second direction. The first bending block group and the second bending block group may be spaced apart from each other in a first direction intersecting the second direction.

Each of the bending blocks may include a first area, a second area, and a third area and a first bending area, and a second bending area. The second area may face each of the first area and the third area at a surface. The first bending area may connect between the first area and the second area, and extend in a substantially bent shape. The second bending area may connect between the second area and the third area, and extend in a substantially bent shape.

Each of the bending blocks may include a first area, a second area, and a third area and a first bending area, and a second bending area. The second area may face each of the first area and the third area at two surfaces. The first bending area may connect between the first area and the second area, and extend in a substantially bent shape. The second bending area may connect between the second area and the third area, and extend in a substantially bent shape.

Each of the bending blocks may include a first area, a second area, and a third area and a fourth and a first bending area, a second bending area, a third bending area and a fourth bending area. The second area may face each of the first area and the third area at a surface. The first bending area and the second bending area may overlap each other in a second direction intersecting the first direction. The third bending area and the fourth bending area may overlap each other in the second direction. The first bending area and the second bending area may connect between the first area and the second area, and extend in a substantially bent shape. The third bending area and the fourth bending area may connect between the second area and the third area, and extend in a substantially bent shape.

### BRIEF DESCRIPTION OF THE DRAWINGS

The above and other aspects and features of the disclosure will become more apparent by describing in detail embodiments thereof with reference to the attached drawings, in which:

FIG. 1 is a schematic perspective view illustrating a stage alignment apparatus in accordance with embodiments.

FIG. 2 is a schematic perspective view illustrating an alignment driving unit (or part) shown in FIG. 1.

FIG. 3 is a detailed schematic perspective view illustrating components of the alignment driving unit shown in FIG. 2 in accordance with an embodiment.

FIGS. 4 and 5 are schematic perspective views illustrating a first sliding block shown in FIG. 3.

FIG. 6 is a schematic perspective view illustrating a first embodiment of a bending block of the first sliding block shown in FIG. 5.

FIG. 7 is a schematic perspective view illustrating a second embodiment of the bending block of the first sliding block shown in FIG. 5.

FIG. 8 is a schematic perspective view illustrating a third embodiment of the bending block of the first sliding block shown in FIG. 5.

FIG. 9 is a view illustrating in detail a third bending area shown in FIG. 8.

FIG. 10 is a view illustrating an embodiment of the stage alignment apparatus in accordance with embodiments.

### DETAILED DESCRIPTION OF THE EMBODIMENTS

Hereinafter, embodiments will be described in more detail with reference to the accompanying drawings. The disclosure will now be described more fully hereinafter with reference to the accompanying drawings, in which embodiments are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

In the drawings, sizes, thicknesses, ratios, and dimensions of the elements may be exaggerated for ease of description and for clarity. Like numbers refer to like elements throughout.

As used herein, the singular forms, “a,” “an,” and “the” are intended to include the plural forms as well, unless the context clearly indicates otherwise.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

In the description below, an operation according to the disclosure is described and the descriptions of other parts may be omitted in order not to unnecessarily obscure subject matters of the disclosure. The disclosure is not limited embodiments described herein, but may be embodied in various different forms. Rather, embodiments described herein are provided to thoroughly and completely describe the disclosed contents of the disclosure to a person of ordinary skill in the art.

Throughout the specification, when an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating an embodiment and not intended to limit the embodiment. It will be understood that when a component “includes” an element, unless there is another opposite description thereto, it should be understood that the component does not exclude another element but may further include another element.

It will be understood that for the purposes of this disclosure, “at least one of X, Y, and Z” can be construed as X only, Y only, Z only, or any combination of two or more items X, Y, and Z (for example, XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (for example, XYZ, XYY, YZ, ZZ).

It will be understood that, although the terms “first, “second,” etc. may be used herein to describe various elements, these elements should not be limited by these terms. These terms are only used to distinguish one element from another element. Thus, a “first” element discussed below could also be termed a “second” element without departing from the teachings of the disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the example term, “above,” may encompass both an orientation of above and below. The apparatus may be otherwise oriented (for example, rotated 90 degrees or at other orientations) and the spatially relative descriptors used herein interpreted accordingly.

The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art.

The terms “face” and “facing” mean that a first element may directly or indirectly oppose a second element. In a case in which a third element intervenes between the first and second element, the first and second element may be understood as being indirectly opposed to one another, although still facing each other.

When an element is described as ‘not overlapping’ or ‘to not overlap’ another element, this may include that the elements are spaced apart from each other, offset from each other, or set aside from each other or any other suitable term as would be appreciated and understood by those of ordinary skill in the art.

The terms “comprises,” “comprising,” “includes,” and/or “including,” “has,” “have,” and/or “having,” and variations thereof when used in this specification, specify the presence of stated features, integers, steps, operations, elements, components, and/or groups thereof, but do not preclude the presence or addition of one or more other features, integers, steps, operations, elements, components, and/or groups thereof.

The embodiments of the disclosure are described here with reference to schematic diagrams (and an intermediate structure) of the disclosure, so that changes in a shape as shown due to, for example, manufacturing technology and/or a tolerance may be expected. Therefore, the embodiments of the disclosure shall not be limited to the shapes of a region as shown, but include shape deviations caused by, for example, the manufacturing technology. The regions shown in the drawings are schematic in nature, and the shapes thereof do not represent the actual shapes of the regions of the device, and do not limit the scope of the disclosure.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Unless otherwise defined or implied herein, all terms (including technical and scientific terms) used herein have the same meaning as commonly understood by one of ordinary skill in the art to which the disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

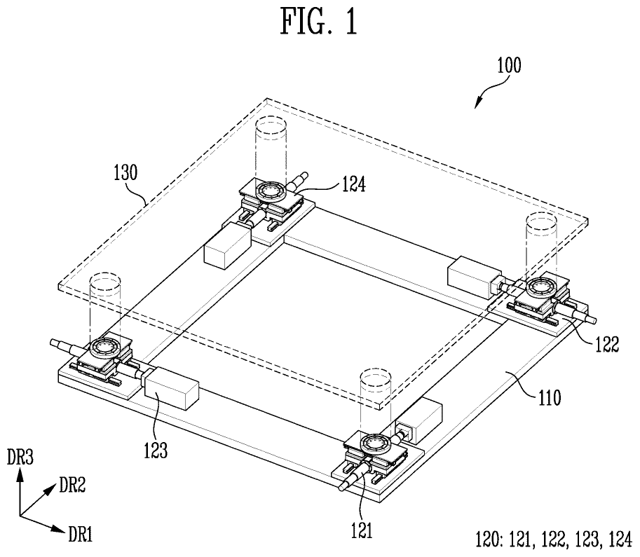

FIG. 1 is a schematic perspective view illustrating a stage alignment apparatus in accordance with embodiments.

Referring to FIG. 1, the stage alignment apparatus 100 may include a lower stage 110, alignment driving units (or drivers or parts) 120, and an upper stage 130.

The lower stage 110 may support the alignment driving units 120 disposed on the lower stage 110. The lower stage 110 may have various shapes in a first direction DR1, a second direction DR2 intersecting the first direction DR1, and a third direction DR3 intersecting the first direction DR1 and the second direction DR2. The lower stage 110 is not necessarily limited to the shape shown in FIG. 1.

The alignment driving units 120 may be disposed on the lower stage 110. Each of the alignment driving units 120 may be fixedly coupled (or connected) on a constant area of the lower stage 110. For example, each of the alignment driving units 120 may be fixedly coupled in the vicinity of each corner of the lower stage 110.

The alignment driving units 120 may include a first alignment driving unit 121, a second alignment driving unit 122, a third alignment driving unit 123, and a fourth alignment driving unit 124. Each of the first to fourth alignment driving units 121 to 124 may be fixedly coupled in the vicinity of each corner of the lower stage 110. The second alignment driving unit 122 may be disposed to be spaced apart from the first alignment driving unit 121 in the second direction DR2. The third alignment driving unit 123 may be disposed to be spaced apart from the first alignment driving unit 121 in the opposite direction of the first direction DR1. The fourth alignment driving unit 124 may be disposed to be spaced apart from the first alignment driving unit 121 in a diagonal direction.

The alignment driving units 120 may support the upper stage 130 disposed on the alignment driving units 120. Also, the alignment driving units 120 may align the upper stage 130 (or adjust a position of the upper stage 130). This will be described in detail below.

The upper stage 130 may be disposed on the alignment driving units 120. The upper stage 130 may be supported by the alignment driving units 120. The upper stage 130 may have various shapes in the first direction DR1, the second direction DR2 intersecting the first direction DR1, and the third direction DR3 intersecting the first direction DR1 and the second direction DR2. The upper stage 130 is not necessarily limited to the shape shown in FIG. 1.

The upper stage 130 may be aligned by the alignment driving units 120 (or the position of the upper stage 130 may be adjusted by the alignment driving units 120). The upper stage 130 may provide a space in which a substrate, a panel or the like is to be disposed.

In various processes related to a substrate, a panel or the like, it may be that the substrate, the panel or the like should exist at an intended position. To this end, it may be important that the upper stage 130 on which the substrate, the panel or the like is disposed should exist at an intended position. The durability of the alignment driving units 120 adjusting the position of the upper stage 130 may be important. In accordance with the embodiments of the disclosure, the durability of the alignment driving units 120 is improved, so that the position adjustment of the upper stage 130 can be precise.

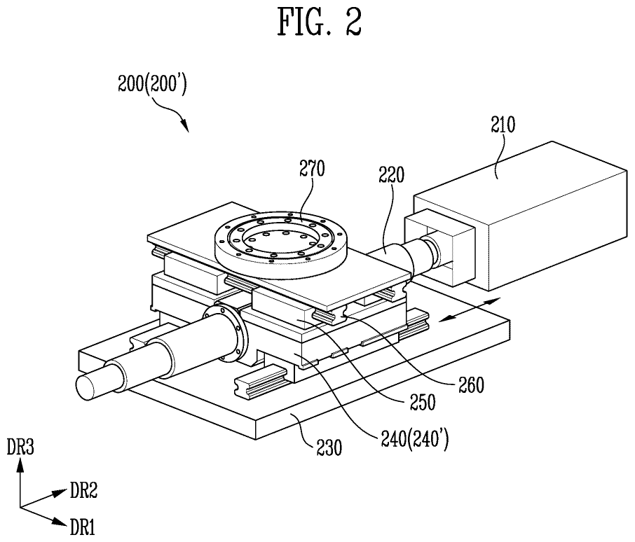

FIG. 2 is a schematic perspective view illustrating the alignment driving unit shown in FIG. 1.

Referring to FIGS. 1 and 2, an alignment driving unit 200 in accordance with an embodiment of the disclosure and an alignment driving unit 200′ in accordance with an embodiment of the disclosure may be provided in the alignment driving units 120 shown in FIG. 1.

The alignment driving unit 200 or 200′ may include a transfer motor 210, a ball screw 220, a first guide block 230, a first sliding block 240 or 240′, a second guide block 250, a second sliding block 260, and a supporter 270. The alignment driving unit 200 in accordance with the embodiment of the disclosure may include a first sliding block 240. The alignment driving unit 200′ in accordance with an embodiment of the disclosure may include a first sliding block 240′.

The transfer motor 210 may be disposed (for example, fixedly coupled) on the lower stage 110. The transfer motor 210 may be connected to the first sliding block 240 or 240′ through the ball screw 220. The transfer motor 210 may push or pull the ball screw 220. In other words, the transfer motor 210 may move the ball screw 220 in one direction (or a direction in which the ball screw 220 extends). The transfer motor 210 may transfer power of the transfer motor 210 to the first sliding block 240 or 240′ through the ball screw 220. The first sliding block 240 or 240′ may move in the same direction as the ball screw 220.

The first guide block 230 may be disposed (for example, fixedly coupled) on the lower stage 110. The first guide block 230 may support the first sliding block 240 or 240′, the second guide block 250, the second sliding block 260, and the supporter 270, which are disposed on the first guide block 230.

The first guide block 230 may provide a space in which the first sliding block 240 or 240′ can move (or slide). Also, the first guide block 230 may limit a moving (or sliding) direction of the first sliding block 240 or 240′. For example, the first guide block 230 may limit the moving (or sliding) direction such that the first sliding block 240 or 240′ can move (or sliding) in only the direction in which the ball screw 220 extends.

The first guide block 230 is not limited to the shape shown in FIG. 2, and may have various shapes as long as the first guide block 230 can perform the above-described function.

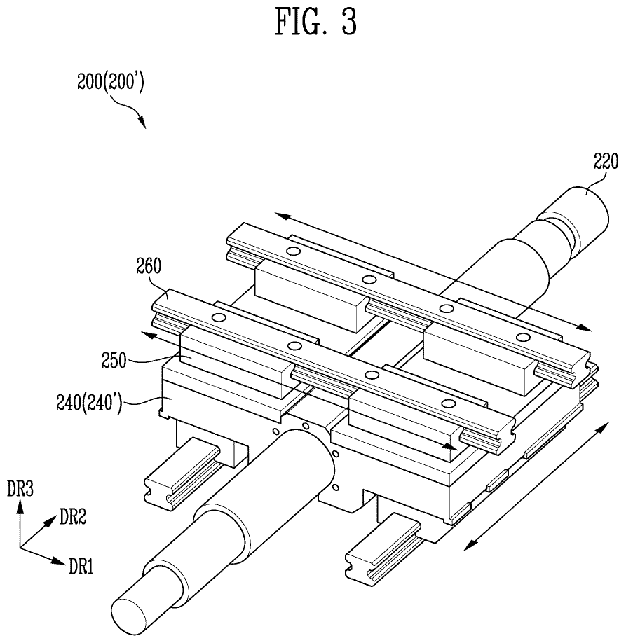

The first sliding block 240 or 240′ may be disposed on the first guide block 230. The first sliding block 240 or 240′ may not be fixedly coupled to the first guide block 230. Also, by the transfer motor 210, the first sliding block 240 or 240′ may move (or slide) on the first guide block 230. The first sliding block 240 or 240′ will be described in detail with reference to FIGS. 3 to 7.

The second guide block 250 may be disposed (for example, fixedly coupled) on the first sliding block 240 or 240′. The second guide block 250 may support the second sliding block 260 and the supporter 270, which are disposed on the second guide block 250.

The second guide block 250 may provide a space in which the second sliding block 260 can move (or slide). Also, the second guide block 250 may limit a moving (or sliding) direction of the second sliding block 260. For example, the second guide block 250 may limit the moving (or sliding) direction such that the second sliding block 240 can move (or slide) in only a direction perpendicular to the direction in which the ball screw 220 extends.

The second sliding block 260 may be disposed on the second guide block 250. The second sliding block 260 may not be fixedly coupled to the second guide block 250. The second sliding block 260 may freely move according to movement of the upper stage 130 disposed on the second sliding block 260. In other words, while the first sliding block 240 or 240′ is moved by the power of the transfer motor, the second sliding block 260 may freely move without separate power.

The supporter 270 may be disposed (or fixedly coupled) on the second sliding block 260. The supporter 270 may support the upper stage 130 disposed on the supporter 270.

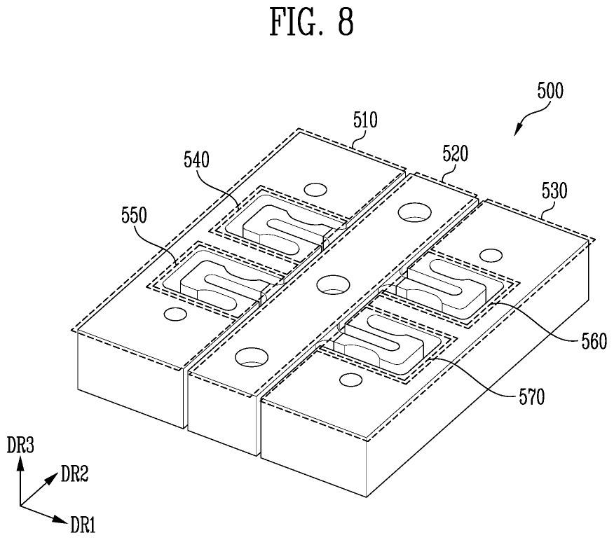

As shown in FIG. 2, the supporter 270 may have a shape including a protrusion portion at a top surface (or upper surface) of a plate extending in the first direction DR1 and the second direction DR2. The upper stage 130 may have holes in some areas. Protrusion portions of supporters 270 of alignment driving units 200 or 200′ may be coupled (for example, fixedly coupled) to the holes of the upper stage 130, so that the upper stage 130 is supported on the alignment driving units 200 or 200′. A position of the upper stage 130 may be adjusted (or aligned) according to movement of the first sliding block 240 or 240′. By way of example, in case that the first sliding block 240 or 240′ moves, power of the first sliding block 240 or 240′ may be transferred to the upper stage 130 via the second sliding block 260 and the supporter 270. The position of the upper stage 130 may be adjusted (or aligned) by the power of the first sliding block 240 or 240′. A detailed operation embodiment will be described in detail later with reference to FIG. 8.

FIG. 3 is a detailed schematic perspective view illustrating components of the alignment driving unit shown in FIG. 2 in accordance with an embodiment.

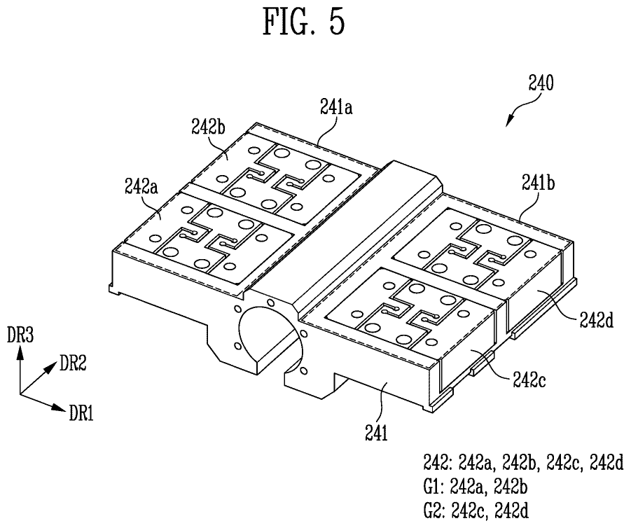

Referring to FIGS. 2 and 3, an alignment driving unit 200′ in accordance with an embodiment of the disclosure may include a ball screw 220, a first sliding block 240, a second guide block 250, and a second sliding block 260. A shape of the first sliding block 240′ will be described in detail later with reference to FIG. 5. An alignment driving unit 200 in accordance with an embodiment of the disclosure may include the ball screw 220, a first sliding block 240, the second guide block 250, and the second sliding block 260. The alignment driving unit 200 in accordance with an embodiment of the disclosure may be different from the alignment driving unit 200′ in accordance with the embodiment of the disclosure in that the alignment driving unit 200 may include the first sliding block 240 instead of the first sliding block 240′. A shape of the first sliding block 240 will be described in detail later with reference to FIGS. 5 to 7.

Each of three alignment driving units among the alignment driving units 120 may include the first sliding block 240′. On the other hand, only any one alignment driving unit among the alignment driving units 120 may include the first sliding block 240.

For example, in case that the first alignment driving unit 121 may include the first sliding block 240, each of the second to fourth alignment driving units 122 to 124 may include the first sliding block 240′.

For example, in case that the second alignment driving unit 122 may include the first sliding block 240, each of the first alignment driving unit 121, the third alignment driving unit 123, and the fourth alignment driving unit 124 may include the first sliding block 240′.

For example, in case that the third alignment driving unit 123 may include the first sliding block 240, each of the first alignment driving unit 121, the second alignment driving unit 122, and the fourth alignment driving unit 124 may include the first sliding block 240′.

For example, in case that the fourth alignment driving unit 124 may include the first sliding block 240, each of the first to third alignment driving units 121 to 123 may include the first sliding block 240′.

As shown in FIG. 3, four second guide blocks 250 may be disposed on the first sliding block 240′. The second guide blocks 250 may be disposed to be spaced apart from each other in the first direction DR1 and the second direction DR2. One second sliding block 260 may be disposed on some second guide blocks 250 among the second guide blocks 250. One second sliding block 260 may be disposed on the other second guide blocks 250 among the second guide blocks 250.

However, embodiments of the disclosure are not necessarily limited thereto. In an embodiment, two second guide blocks 250 may be disposed on the first sliding block 240′. The second guide blocks 250 may be disposed to be spaced apart from each other in the first direction DR1. One second sliding block 260 may be disposed on the second guide blocks 250.

The first sliding block 240′ and the second sliding block 260 may move (or sliding) in directions perpendicular to each other. For example, the first sliding block 240′ may move (or slide) in the second direction DR2 (or the direction in which the ball screw 220 extends). On the other hand, the second sliding block 260 may move (or slide) in the first direction DR1 (or a direction perpendicular to the direction in which the ball screw 220 extends).

A case where the second sliding block 260 moves by a constant distance in the first direction DR1 at the same time in case that the first sliding block 240′ moves by a constant distance in the second direction DR2 will be described as an example. The supporter 270 and the upper stage 130, which are disposed on the second sliding block 260, may be in a state in which the supporter 270 and the upper stage 130 moves by a constant distance in the first direction DR1 and the second direction DR2 from an initial position. In this manner, a position of the upper stage 130 may be adjusted.

It is assumed that each of the first to fourth alignment driving units 121, 122, 123, and 124 may include the first sliding block 240′. In other words, it is assumed that any one alignment driving unit among the alignment driving units 120 does not include the first sliding block 240. The first sliding blocks 240′ may receive power of the transfer motor 210 in a state in which a high load is applied on the first sliding block 240′. The first sliding blocks 240′ may be heated by heat caused by friction or the like, and the shape of each of the first sliding blocks 240′ may be deformed by a mechanical force. For example, top surfaces (or upper surface) of the first sliding blocks 240′ (or surfaces in contact with the second guide blocks 250) may be heated by heat caused by friction or the like, and the shape of each of the top surfaces (or upper surfaces) may be deformed by a mechanical force.

On the other hand, in the stage alignment apparatus 100 in accordance with the embodiments of the disclosure, any one alignment driving unit among the alignment driving units 120 may include the first sliding block 240. The first sliding block 240 receives power of the transfer motor 210 in a state in which a high load is applied on the first sliding block 240. Even in case that the first sliding block 240 is heated by heat caused by friction or the like and in case that a mechanical force is applied to the first sliding block 240, the first sliding block 240 can readily distribute force, heat or the like as compared with the first sliding block 240′. Accordingly, the first sliding block 240 can have excellent durability against deformation as compared with the first sliding block 240′. Thus, in the stage alignment apparatus 100 in accordance with the embodiments of the disclosure, any one alignment driving unit among the alignment driving units 120 may include the first sliding block 240, so that durability of the alignment driving units 120 can be improved.

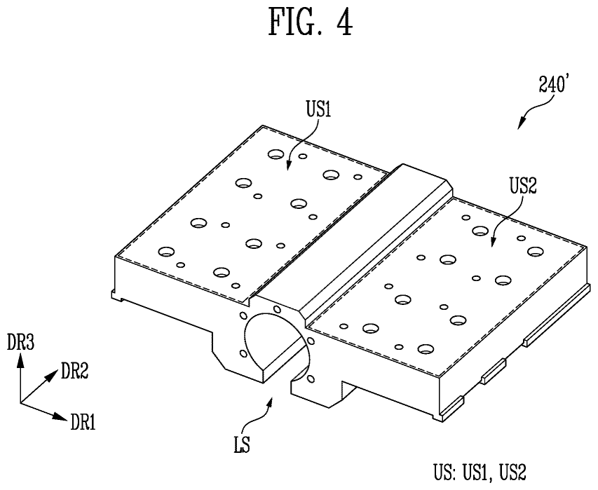

FIGS. 4 and 5 are schematic perspective views illustrating the first sliding block shown in FIG. 3. By way of example, FIG. 4 is a schematic perspective view illustrating the first sliding block 240′ shown in FIG. 3. FIG. 5 is a schematic perspective view illustrating the first sliding block 240.

Referring to FIGS. 3 and 4, the first sliding block 240′ may include an upper surface US and a lower surface LS.

The second guide blocks 250 may be coupled (for example, fixedly coupled) on the upper surface US of the first sliding block 240′. By way of example, the upper surface US of the first sliding block 240′ may include a first area US1 and a second area US2. Some of the second guide blocks 250 may be coupled (for example, fixedly coupled) on the first area US1 of the upper surface US. The others of the second guide blocks 250 may be coupled (for example, fixedly coupled) on the second area US2 of the upper surface US.

The first sliding block 240′ may include a portion having an arch shape. However, this is used such that the first sliding block 240′ is coupled to the ball screw 220 having a cylindrical shape, and embodiments of the disclosure are not necessarily limited thereto. In an embodiment, in case that the ball screw 220 has a rectangular parallelepiped shape, the first sliding block 240′ may not include the portion having the arch shape.

Referring to FIGS. 3 and 5, the first sliding block 240 may include a body 241 and bending blocks 242.

The body 240 may be connected to the ball screw 220, to receive the power of the transfer motor 210 through the ball screw 220. The first sliding block 240 may include a portion having an arch shape. However, this is used such that the first sliding block 240 is coupled to the ball screw 220 having a cylindrical shape, and embodiments of the disclosure are not necessarily limited thereto. In an embodiment, in case that the ball screw 220 has a rectangular parallelepiped shape, the first sliding block 240 may not include the portion having the arch shape.

The bending blocks 242 may be coupled (or fixedly coupled) on the body 241. For example, the body 241 may include a first area 241a and a second area 241b. Also, the bending blocks 242 may include a first bending block 242a, a second bending block 242b, a third bending block 242c, and a fourth bending block 242d. Some (for example, the first bending block 242a and the second bending block 242b) of the bending blocks 242 may be coupled on the first area 241a of the body 241. The others (for example, the third bending block 242c and the fourth bending block 242d) of the bending blocks 242 may be coupled on the second area 241b of the body 241.

The bending blocks 242 coupled on the first area 241a of the body 241 may form a first bending block group G1. The bending blocks 242 coupled on the second area 241b of the body 241 may form a second bending block group G2. As shown in FIG. 5, the first bending block group G1 and the second bending block group G2 may be spaced apart from each other in the first direction DR1. The bending blocks 242 included in the first bending block group G1 may be adjacent to each other in the second direction DR2. The bending blocks 242 included in the second bending block group G2 may be adjacent to each other in the second direction DR2.

The second guide blocks 250 may be coupled (for example, fixedly coupled) on the bending blocks 242. For example, one second guide block 250 may be coupled (for example, fixedly coupled) on each of the first to fourth bending blocks 242a, 242b, 242c, and 242d.

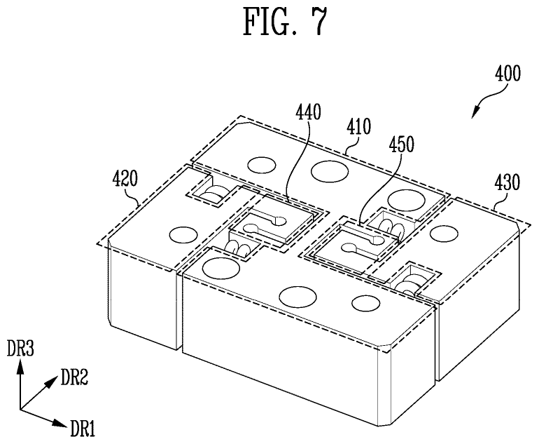

A detailed shape of the bending blocks 242 will be described in detail later with reference to FIGS. 7 and 8.

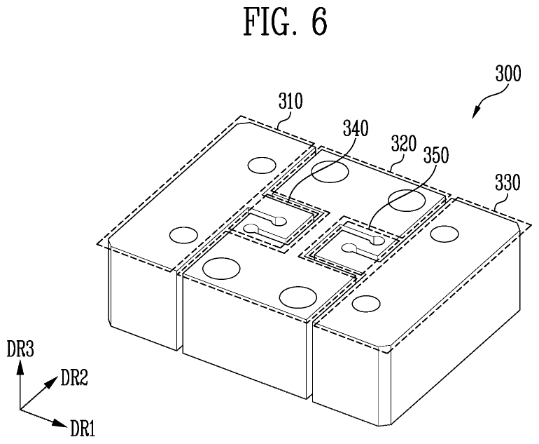

FIG. 6 is a schematic perspective view illustrating a first embodiment of the bending block of the first sliding block shown in FIG. 5.

Referring to FIGS. 5 and 6, a bending block 300 in accordance with a first embodiment of the disclosure may be provided in the first to fourth bending blocks 242a, 242b, 242c, and 242d shown in FIG. 5.

The bending block 300 may have a three-dimensional shape extending in the first to third direction DR1 to DR3.

The bending block 300 may include a first area 310, a second area 320, a third area 330, a first bending area 340, and a second bending area 350.

Referring to FIG. 6, the first area 310 to the third area 330 of the bending block 300 may be disposed side by side in the first direction DR1.

One surface or a surface of the first area 310 of the bending block 300 may face one surface or a surface of the second area 320 of the bending block 300. The one surface of the first area 310 of the bending block 300 may face the one surface of the second area 320 of the bending block 300 in the first direction DR1.

One surface or a surface of the third area 330 of the bending block 300 may face the other surface facing the one surface of the second area 320 of the bending block 300. The one surface of the third area 330 of the bending block 300 may face the other surface facing the one surface of the second area 320 of the bending block 300 in the first direction DR1.

In the first bending area 340, the bending block 300 may connect between the bending block 300 of the first area 310 and the bending block 300 of the second area 320. The bending block 300 of the first bending area 340 may extend in a bent shape as shown in FIG. 6.

Similarly, in the second bending area 350, the bending block 300 may connect between the bending block 300 of the second area 320 and the bending block 300 of the third area 330. The bending block 300 of the second bending area 350 may extend in a bent shape as shown in FIG. 6.

In an embodiment, the bending block 300 may further include additional bending areas in addition to the first bending area 340 and the second bending area 350. In some areas among the additional bending areas, the bending block 300 may connect between the bending block 300 of the first area 310 and the bending block 300 of the second area 320. In the other areas among the additional bending areas, the bending block 300 may connect between the bending block 300 of the second area 320 and the bending block 300 of the third area 330.

In an embodiment, the bending block 300 may include an elastic material.

FIG. 7 is a schematic perspective view illustrating a second embodiment of the bending block of the first sliding block shown in FIG. 5.

Referring to FIGS. 5 and 7, a bending block 400 in accordance with a second embodiment of the disclosure may be provided in the first to fourth bending blocks 242a, 242b, 242c, and 242d shown in FIG. 5.

The bending block 400 may have a three-dimensional shape extending in the first to third directions DR1 to DR3.

The bending block 400 may include a first area 410, a second area 420, a third area 430, a first bending block 440, and a second bending block 450.

Referring to FIG. 7, the first area 410 to the third area 430 of the bending block 400 may be disposed side by side in the first direction DR1.

The first area 410 of the bending block 400 may face the second area 420 of the bending block 400 at two surfaces thereof. The first area 410 of the bending block 400 may face the second area 420 of the bending block 400 in the first direction DR1 and the second direction DR2.

The first area 410 of the bending block 400 may face the third area 430 of the bending block 400 at two surfaces thereof. A surface at which the first area 410 and the second area 420 of the bending block 400 face each other may be different from a surface at which the first area 410 and the third area 430 of the bending block 400 face each other.

In the first bending area 440, the bending block 400 may connect between the bending block 400 of the first area 410 and the bending block 400 of the second area 420. The bending block 400 of the first bending area 440 may extend in a bent shape as shown in FIG. 7.

Similarly, in the second bending area 450, the bending block 400 may connect between the bending block 400 of the first area 410 and the bending block 400 of the third area 430. The bending block 400 of the second bending area 450 may extend in a bent shape as shown in FIG. 7.

In an embodiment, the bending block 400 may further include additional bending areas in addition to the first bending area 440 and the second bending area 450. In some areas among the additional bending areas, the bending block 400 may connect between the bending block 400 of the first area 410 and the bending block 400 of the second area 420. In the other areas among the additional bending areas, the bending block 400 may connect between the bending block 400 of the first area 410 and the bending block 400 of the third area 430.

In an embodiment, the bending block 400 may include an elastic material.

FIG. 8 is a schematic perspective view illustrating a third embodiment of the bending block of the first sliding block shown in FIG. 5.

Referring to FIGS. 5 and 8, a bending block 500 in accordance with a third embodiment of the disclosure may be provided in the first to fourth bending blocks 242a, 242b, 242c, and 242d shown in FIG. 5.

The bending block 500 may have a three-dimensional shape extending in the first to third directions DR1 to DR3.

The bending block 500 may include a first area 510, a second area 520, a third area 530, a first bending area 540, a second bending area 550, a third bending area 560, and a fourth bending area 570.

Referring to FIG. 8, the first area 510 and the third area 530 of the bending block 500 may be disposed side by side in the first direction DR1.

One surface or a surface of the first area 510 of the bending block 500 may face one surface or a surface of the second area 520 of the bending block 500. The one surface of the first area 510 of the bending block 500 may face the one surface of the second area 520 of the bending block 500 in the first direction DR1.

One surface or a surface of the third area 530 of the bending block 500 may face the other surface facing the one surface of the second area 520 of the bending block 500. The one surface of the third area 530 of the bending block 500 may face the other surface facing the one surface of the second area 520 of the bending block 500 in the first direction DR1.

In the first bending area 540, the bending block 500 may connect between the bending block 500 of the first area 510 and the bending block 500 of the second area 520. The bending block 500 of the first bending area 540 may extend in a bent shape as shown in FIG. 8.

Similarly, in the second bending area 550, the bending block 500 may connect between the bending block 500 of the first area 510 and the bending block 500 of the second area 520. The bending block 500 of the second bending area 540 may extend in a bent shape as shown in FIG. 8.

The first bending area 540 and the second bending area 550 may overlap each other while being spaced part from each other in the second direction DR2.

In the third bending area 560, the bending block 500 may connect between the bending blocking 500 of the second area 520 and the bending block 500 of the third area 530. The bending block 500 of the third bending area 560 may extend in a bent shape as shown in FIG. 8.

Similarly, in the fourth bending area 570, the bending block 500 may connect between the bending block 500 of the second area 520 and the bending block 500 of the third area 530. The bending block 500 of the fourth bending area 570 may extend in a bent shape as shown in FIG. 8.

The third bending area 560 and the fourth bending area 570 may overlap each other while being spaced apart from each other in the second direction DR2.

In an embodiment, the bending block 500 may further include additional being areas in addition to the first to fourth bending areas 540 to 570. In some areas of the additional bending areas, the bending block 500 may connect between the bending block 500 of the first area 510 and the bending block 500 of the second area 520. In the other areas of the additional bending areas, the bending block 500 may connect between the bending block 500 of the second area 520 and the bending block 500 of the third area 530.

In an embodiment, the bending block 500 may include an elastic material.

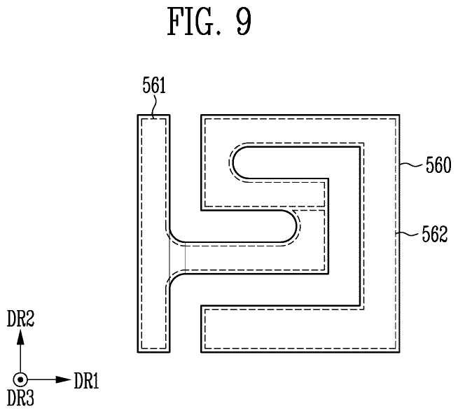

FIG. 9 is a view illustrating in detail the third bending area shown in FIG. 8. Hereinafter, the third bending area 560 is described as an example, but the first bending area 540, the second bending area 550, and the fourth bending area 570 are the same as the third bending area 560.

Referring to FIG. 9, the third bending area 560 may include a thirty-first sub-bending area 561 and a thirty-second sub-bending area 562.

As shown in FIG. 9, each of the thirty-first sub-bending area 561 and the thirty-second sub-bending area 562 may extend while including a bent portion. Also, the thirty-first sub-bending area 561 and the thirty-second sub-bending area 562 may be connected to each other in a partial area, and may not be in contact with each other an area except the partial area.

In FIG. 9, it is illustrated that an end of each of the thirty-first sub-bending area 561 and the thirty-second sub-bending area 562 has an angular shape. However, embodiments of the disclosure are not necessarily limited thereto. For example, the end of each of the thirty-first sub-bending area 561 and the thirty-second sub-bending area 562 may have a round shape (or non-angular shape).

Any one alignment driving unit among the alignment driving units 120 may include a first sliding block 240 including bending blocks 500 including a third bending area 560. In a process of adjusting the position of the upper stage 130, the first sliding block 240 receives the power of the transfer motor 210 in a state in which a high load is applied on the first sliding block 240. The first sliding block 240 is heated by heat caused by friction or the like within the spirit and the scope of the disclosure. Although a mechanical force is applied, the first sliding block 240 can readily distribute force, heat or the like as compared with the first sliding block 240′. Accordingly, the first sliding block 240 can have excellent durability against deformation as compared with the first sliding block 240′. Thus, in the stage alignment apparatus 100 in accordance with the embodiments of the disclosure, the first sliding block 240 including the bending blocks 500 including the third bending area 560 is included in any one alignment driving unit among the alignment driving units 120, so that the durability of the alignment driving units 120 can be improved.

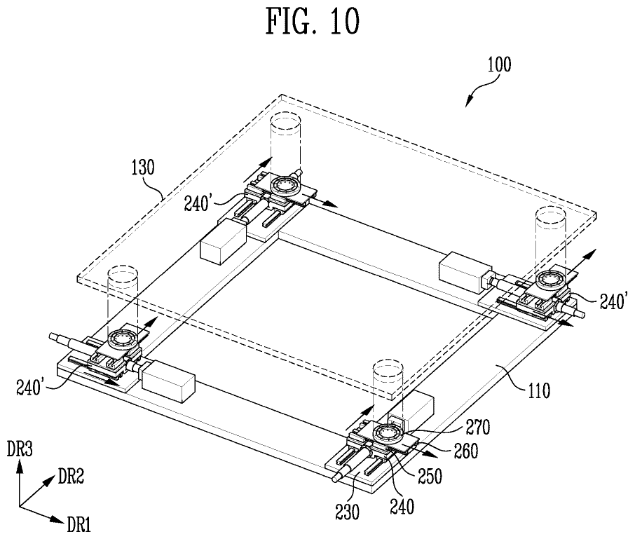

FIG. 10 is a view illustrating an embodiment of the stage alignment apparatus in accordance with embodiments.

Referring to FIGS. 1 and 10, a stage alignment apparatus 100 may include first to fourth alignment driving units 121 to 124.

In accordance with embodiments, only any one alignment driving unit among the first to fourth alignment driving units 121 to 124 may include a first sliding block 240. Each of the other alignment driving units may include a first sliding block 240′. Hereinafter, it is assumed and described that the first alignment driving unit 121 may include the first sliding block 240.

A first sliding block 240 or 240′ and a second sliding block 260, which each of the first to fourth alignment driving units 121 to 124 may include, may move (or slide) in directions perpendicular to each other.

For example, a first sliding block 240 of the first alignment driving unit 121 may move (or slide) in the second direction DR2, and a second sliding block 260 of the first alignment driving unit 121 may move (or slide) in the first direction DR1.

For example, a first sliding block 240′ of the second alignment driving unit 122 may move (or slide) in the first direction DR1, and a second sliding block 260 of the second alignment driving unit 122 may move (or slide) in the second direction DR2.

For example, a first sliding block 240′ of the third alignment driving unit 123 may move (or slide) in the first direction DR1, and a second sliding block 260 of the third alignment driving unit 123 may move (or slide) in the second direction DR2.

For example, a first sliding block 240′ of the fourth alignment driving unit 124 may move (or slide) in the second direction DR2, and a second sliding block 260 of the fourth alignment driving unit 124 may move (or slide) in the first direction DR1.

One operation embodiment of the stage alignment apparatus in accordance with the embodiments of the disclosure is shown in FIG. 10.

In FIG. 10, by the transfer motor 210, the first sliding block 240′ of each of the second alignment driving unit 122 and the third alignment driving unit 123 may move in the first direction DR1.

In FIG. 10, by the transfer motor 210, the first sliding block 240 of the first alignment driving unit 121 may move in the second direction DR2.

In FIG. 10, by the transfer motor 210, the first sliding block 240′ of the fourth alignment driving unit 124 may move in the second direction DR2.

Power of the first sliding block of each of the first to fourth alignment driving units 121 to 124 may be transferred to the upper stage 130 through the second sliding block and a supporter. By the power of the first sliding blocks, the upper stage 130 may move in the first direction DR1 and the second direction DR2.

As the upper stage 130 moves, a second sliding block 260 of each of the second alignment driving unit 122 and the third alignment driving unit 123 may move in the second direction DR2. A second sliding block 260 of the first alignment driving unit 121 may move in the first direction DR1. A second sliding block 260 of the fourth alignment driving unit 124 may move in the first direction DR1.

In this manner, in the stage alignment apparatus in accordance with the embodiments of the disclosure, the position of the upper stage 130 can be adjusted (or aligned).

In the stage alignment apparatus 100 in accordance with the embodiments of the disclosure, any one alignment driving unit among the alignment driving units 120 may include a first sliding block 240. In a process of adjusting the position of the upper stage 130, the first sliding block 240 receives the power of the transfer motor 210 in a state in which a high load is applied on the first sliding block 240. The first sliding block 240 is heated by heat caused by friction or the like within the spirit and the scope of the disclosure. Although a mechanical force is applied, the first sliding block 240 can readily distribute force, heat or the like as compared with the first sliding block 240′. Accordingly, the first sliding block 240 can have excellent durability against deformation as compared with the first sliding block 240′. Thus, in the stage alignment apparatus 100 in accordance with the embodiments of the disclosure, the first sliding block 240 is included in any one alignment driving unit among the alignment driving units 120, so that the durability of the alignment driving units 120 can be improved.

In accordance with the disclosure, there can be provided a stage alignment apparatus having high durability by efficiently removing deformation caused by a vertical load, and a driving method of the stage alignment apparatus.

Example embodiments have been disclosed herein, and although terms are employed, they are used and are to be interpreted in a generic and descriptive sense only and not for purpose of limitation. In some instances, as would be apparent to one of ordinary skill in the art, features, characteristics, and/or elements described in connection with an embodiment may be used singly or in combination with features, characteristics, and/or elements described in connection with other embodiments unless otherwise indicated. Accordingly, it will be understood by those of ordinary skill in the art that various changes in form and details may be made without departing from the spirit and scope of the disclosure and as set forth in the following claims.

What is claimed is:

1. A stage alignment apparatus comprising:
a lower stage;
alignment drivers disposed on the lower stage; and
an upper stage aligned by the alignment drivers, wherein
each of the alignment drivers includes a first sliding block and a second sliding block slidable in directions perpendicular to each other, and
a shape of a first sliding block of at least one alignment driver among the alignment drivers is substantially different from a shape of first sliding blocks of other alignment drivers among the alignment drivers.

2. The stage alignment apparatus of claim 1, wherein the first sliding block of the at least one alignment driver includes bending blocks.

3. The stage alignment apparatus of claim 2, wherein
the bending blocks are divided into a first bending block group and a second bending block group, each of the first bending block group and the second bending block group including at least one bending block,
the bending blocks included in the first bending block group are adjacent to each other in a second direction, and
the first bending block group and the second bending block group are spaced apart from each other in a first direction intersecting the second direction.

4. The stage alignment apparatus of claim 2, wherein the bending blocks of the first sliding block of the at least one alignment driver include an elastic material.

5. The stage alignment apparatus of claim 2, wherein
each of the bending blocks includes a first area, a second area, and a third area and a first bending area and a second bending area,
the second area faces each of the first area and the third area at a surface,
the first bending area connects between the first area and the second area, and extends in a substantially bent shape, and
the second bending area connects between the second area and the third area, and extends in a substantially bent shape.

6. The stage alignment apparatus of claim 2, wherein
each of the bending blocks includes a first area, a second area, and a third area and a first bending area and a second bending area,
the second area faces each of the first area and the third area at two surfaces,
the first bending area connects between the first area and the second area, and extends in a substantially bent shape, and
the second bending area connects between the second area and the third area, and extends in a substantially bent shape.

7. The stage alignment apparatus of claim 2, wherein
each of the bending blocks includes a first area, a second area and a third area and a first bending area, a second bending area, a third bending area and a fourth bending area,
the second area faces each of the first area and the third area at a surface,
the first and second bending areas overlap each other in a second direction,
the third bending area and the fourth bending area overlap each other in the second direction,
the first bending area and the second bending area connect between the first area and the second area, and extend in a substantially bent shape, and
the third bending area and the fourth bending area connect between the second area and the third area, and extend in a substantially bent shape.

8. The stage alignment apparatus of claim 1, wherein the alignment drivers include a first alignment driver, a second alignment driver, a third alignment driver, and a fourth alignment driver.

9. The stage alignment apparatus of claim 1, wherein each of the alignment drivers further includes:
a first guide block disposed between the lower stage and the first sliding block;
a second guide block disposed between the first sliding block and the second sliding block;
a supporter disposed on the second sliding block, the supporter that connects between each of the alignment drivers and the upper stage;
a transfer motor transferring the first sliding block in a direction; and
a ball screw connecting between the first sliding block and the transfer motor.

10. The stage alignment apparatus of claim 9, wherein the ball screw has a substantially cylindrical shape and extends in a direction.

11. The stage alignment apparatus of claim 9, wherein
the supporter includes a protrusion portion disposed at an upper surface of the supporter,
the upper stage includes holes in a number of areas, and
the protrusion portion of each of the alignment drivers is connected to each of the holes of the upper stage, to support the upper stage on the alignment drivers.

12. The stage alignment apparatus of claim 9, wherein
the first guide block is connected to the lower stage, and limits a sliding direction of the first sliding block, and
the second guide block is connected to the first sliding block, and limits a sliding direction of the second sliding block.

13. The stage alignment apparatus of claim 9, wherein the first sliding block of each of the other alignment drivers among the alignment drivers includes:
an upper surface on which the second guide block is disposed; and
a lower surface connected to the ball screw, to transfer power of the transfer motor.

14. The stage alignment apparatus of claim 9, wherein the first sliding block of the at least one alignment driver includes:
a body connected to the ball screw, to transfer power to the transfer motor, the body including a portion having a substantially arch shape; and
bending blocks connected on the body.

15. A method of driving a stage alignment apparatus including alignment drivers including a first sliding block and a second sliding block slidable in directions perpendicular to each other and an upper stage aligned by the alignment drivers, the method comprising:
moving the upper stage by moving the first sliding block of each of the alignment drivers; and
moving the second sliding block of each of the alignment drivers according to a movement of the upper stage,
wherein a shape of a first sliding block of at least one alignment driver among the alignment drivers is substantially different from a shape of first sliding blocks of other alignment drivers among the alignment drivers.

16. The method of claim 15, wherein the first sliding block of the at least one alignment driver includes bending blocks.

17. The method of claim 16, wherein
the bending blocks are divided into a first bending block group and a second bending block group, each of which includes at least one bending block,
the bending blocks included in the first bending block group are adjacent to each other in a second direction, and
the first bending block group and the second bending block group are spaced apart from each other in a first direction intersecting the second direction.

18. The method of claim 16, wherein
each of the bending blocks includes a first area, a second area, and a third area and a first bending area and a second bending area,
the second area faces each of the first area and the third area at a surface,
the first bending area connects between the first area and the second area, and extends in a substantially bent shape, and
the second bending area connects between the second area and the third area, and extends in a substantially bent shape.

19. The method of claim 16, wherein
each of the bending blocks includes a first area, a second area, and a third area and a first bending area and a second bending area,
the second area faces each of the first area and the third area at two surfaces,
the first bending area connects between the first area and the second area, and extends in a substantially bent shape, and
the second bending area connects between the second area and the third area, and extends in a substantially bent shape.

20. The method of claim 16, wherein
each of the bending blocks includes a first area, a second area, and a third area and a first bending area, a second bending area, a third bending area, and a fourth bending area,
the second area faces each of the first area and the third area at a surface,
the first bending area and second bending area overlap each other in a second direction,
the third bending area and the fourth bending area overlap each other in the second direction,
the first bending area and the second bending area connect between the first area and the second area, and extend in a substantially bent shape, and
the third bending area and the fourth bending area connect between the second area and the third area, and extend in a substantially bent shape.
